(19) United States
(12) Patent Application Publication
(10) Pub. No.: US 2018/0339674 A1
(43) Pub. Date: Nov. 29, 2018

(54) ISOLATED FLUID RESERVOIR IN A VEHICLE FOR PEDESTRIAN PROTECTION

(71) Applicant: Ford Global Technologies, LLC, Dearborn, MI (US)

(72) Inventors: Robert Alex Mitchell, Plymouth, MI (US); Daniel Robert Tylutki, Livonia, MI (US)

(21) Appl. No.: 15/603,813

(22) Filed: May 24, 2017

(51) Int. Cl. B60R 21/34; F16F 1/36; B60K 11/04; F16F 9/10; F16F 1/06; F16F 1/373; F01P 11/02

(52) U.S. Cl. CPC B60R 21/34; F16F 1/36; B60K 11/04; F01P 11/029; F16F 1/06; F16F 1/373; F16F 9/10

(57) ABSTRACT

An isolated coolant reservoir displaceable from an operational position to a position pushed out of the Pedestrian Protection Zone in an impact event is provided. The reservoir relative to the vehicle's body structure is generally isolated either by external damping structures or by integrated or internal flexible mounts. Structures that provide external damping of the reservoir relative to the vehicle's body structure include flexible polymerized isolators and flexible metal isolators. Flexible polymerized isolators may be compressible insulators or may be flexible arms, both of which are positioned between the integral arms of the reservoir and the body structure. Flexible metal isolators may be springs or dampers. Integrated or internal flexible mounts include angular flexible arms having slotted ends that extend from the reservoir to the body structure. Further variations of the integrated arm structure include a living hinge incorporated into the arm and arcuate arm.

### TECHNICAL FIELD

The disclosed inventive concept relates generally to pedestrian protection systems for automotive vehicles. More particularly, the disclosed inventive concept relates to a pedestrian protection system that includes a coolant system having an isolated coolant reservoir in the form of a bottle or tank that is held in position during normal vehicle operation but that allows for the coolant reservoir to be moved out of the Pedestrian Protection Zone in an impact event, thus ensuring the safety of pedestrians.

### BACKGROUND OF THE INVENTION

Increased attention is being given the world over to pedestrian-vehicle impacts as more vehicles appear on the roadways, particularly in developing countries. As a consequence, government studies related to the protection of pedestrians in vehicle impact events are also increasing. For example, pedestrian protection has become a goal of the United Nations Economic Commission for Europe. The UNECE advanced a proposal “to develop a global technical regulation concerning the protection of pedestrians and other vulnerable road users in collision with vehicles and final report on the development of the global technical regulation concerning pedestrian safety.” Along with the Global Technical Regulation No. 9 (GTR-9), the European New Car Assessment Programme (Euro NCAP) developed a pedestrian protection star rating system. Vehicle manufacturers must meet child head, adult head, upper leg and lower leg test requirements provided to assess vehicle designs for mitigation of pedestrian injury caused by a vehicle frontal impact.

To reduce pedestrian injuries and to meet current and emerging global safety regulations, automotive companies are implementing Pedestrian Protection Systems. These systems often require additional space under the vehicle's engine hood that either avoid the provision of engine or engine-related components in the Pedestrian Protection Zone or provide for breakaway components that fall out of the zone in an impact event.

Often engine cooling components are, of necessity, located in or near the Pedestrian Protection Zone and are subject to the applicable safety requirements in their design criteria. The coolant reservoir is typically packaged just below the vehicle's engine hood, thus allowing convenient access for coolant fills. This location frequently places the coolant reservoir within the Pedestrian Protection Zone below the engine hood. This situation becomes more complicated as it is desired for the reservoir to be located near the front of the vehicle. Because the gap between the underside of the engine hood and the under-hood components typically reduces toward the front of the vehicle, the coolant reservoir, being typically placed vehicle-forward, is a component that often presents challenges to under-hood component placement and design.

As in so many areas of vehicle technology, there is room for improvement related to the protection of pedestrians in a pedestrian-vehicle impact event.

### SUMMARY OF THE INVENTION

The disclosed inventive concept overcomes the problems of known technology by providing an isolated coolant reservoir capable of being displaced from its operational position during normal vehicle use to a position that is pushed out of the Pedestrian Protection Zone in an impact event. The isolated coolant reservoir relative to the vehicle's body structure according to the disclosed inventive concept is generally isolated either by external damping structures or by integrated or internal flexible mounts. In an impact event, the coolant reservoir is pushed from its operational position out of the Pedestrian Protection Zone ensuring the safety of pedestrians.

Structures that provide external damping of the coolant reservoir relative to the vehicle's body structure include both flexible polymerized isolators and flexible metal isolators. These structures are provided between the vehicle's body structure and arms that extend from and are integrally part of the reservoir. Flexible polymerized isolators may be compressible insulators or may be flexible arms, both of which are positioned between the integral arms of the coolant reservoir and the vehicle's body structure. Flexible metal isolators may be springs or gas- or fluid-filled dampers.

Integrated or internal flexible mounts that are integrally molded with the coolant reservoir include angular flexible arms having slotted ends that extend from the reservoir to the body structure. The slotted ends of the arms are displaceable relative to the body structure in an impact event. An additional variation of the integrated arm structure is the incorporation into the integral arm of a living hinge. A further variation of the integrated arm structure is an arcuate arm that functions like a spring in an impact event.

Each embodiment of the coolant reservoir allows for movement of the reservoir from the Pedestrian Protection Zone in an impact event. The embodiments may be combined for use in a single coolant reservoir. The structures connecting the coolant reservoir to the vehicle body structure may be readily tuned according to the force required for movement of the coolant reservoir. Tuning may be accomplished by, for example, adjusting the spring constant, material thickness and material type.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is an environmental view of engine compartment of an automobile according to the prior art;

FIG. 2 is a side view of an isolated coolant reservoir assembly according to the disclosed inventive concept having polymerized isolators perpendicularly positioned between the arms of the reservoir and the vehicle body structure, the assembly being shown before an impact event;

FIG. 3 is a view of the isolated coolant reservoir assembly similar to that of FIG. 2, but illustrating the assembly following an impact event;

FIG. 4 is a side view of an isolated coolant reservoir assembly according to the disclosed inventive concept having dampers as isolators positioned between the arms of the reservoir and the vehicle body structure, the assembly being shown before an impact event;

FIG. 5 is a view of the isolated coolant reservoir assembly similar to that of FIG. 4, but illustrating the assembly following an impact event;

FIG. 6 is a side view of an isolated coolant reservoir assembly according to the disclosed inventive concept having springs as isolators positioned between the arms of the reservoir and the vehicle body structure, the assembly being shown before an impact event;

FIG. 7 is a view of the isolated coolant reservoir assembly similar to that of FIG. 6, but illustrating the assembly following an impact event;

FIG. 8 is a side view of an isolated coolant reservoir assembly according to the disclosed inventive concept having polymerized isolators angularly positioned between the arms of the reservoir and the vehicle body structure, the assembly being shown before an impact event;

FIG. 9 is a view of the isolated coolant reservoir assembly similar to that of FIG. 6, but illustrating the assembly following an impact event;

FIG. 10 is a side view of an isolated coolant reservoir assembly according to the disclosed inventive concept having angular flexible arms integrally formed with the reservoir and extending to the vehicle body structure, the assembly being shown before an impact event;

FIG. 11 is a view of the isolated coolant reservoir assembly similar to that of FIG. 10, but illustrating the assembly following an impact event;

FIG. 12 is a side view of an isolated coolant reservoir assembly according to the disclosed inventive concept having arms with living hinges integrally formed with the reservoir and extending to the vehicle body structure, the assembly being shown before an impact event;

FIG. 13 is a view of the isolated coolant reservoir assembly similar to that of FIG. 12, but illustrating the assembly following an impact event;

FIG. 14 is a side view of an isolated coolant reservoir assembly according to the disclosed inventive concept having arcuate flexible arms integrally formed with the reservoir and extending to the vehicle body structure, the assembly being shown before an impact event; and

FIG. 15 is a view of the isolated coolant reservoir assembly similar to that of FIG. 14, but illustrating the assembly following an impact event.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

The accompanying figures and the associated description illustrate the engine cover according to the disclosed inventive concept. It is to be understood that the shape, size, and position of the isolated fluid reservoir as illustrated in the figures are suggestive and are not intended as being limiting. As a non-limiting example, the illustrated shape of the isolated fluid reservoir is shown as being generally rectangular but may be adapted as needed for a certain space. As a further non-limiting example, the isolated fluid reservoir may have an irregular shape.

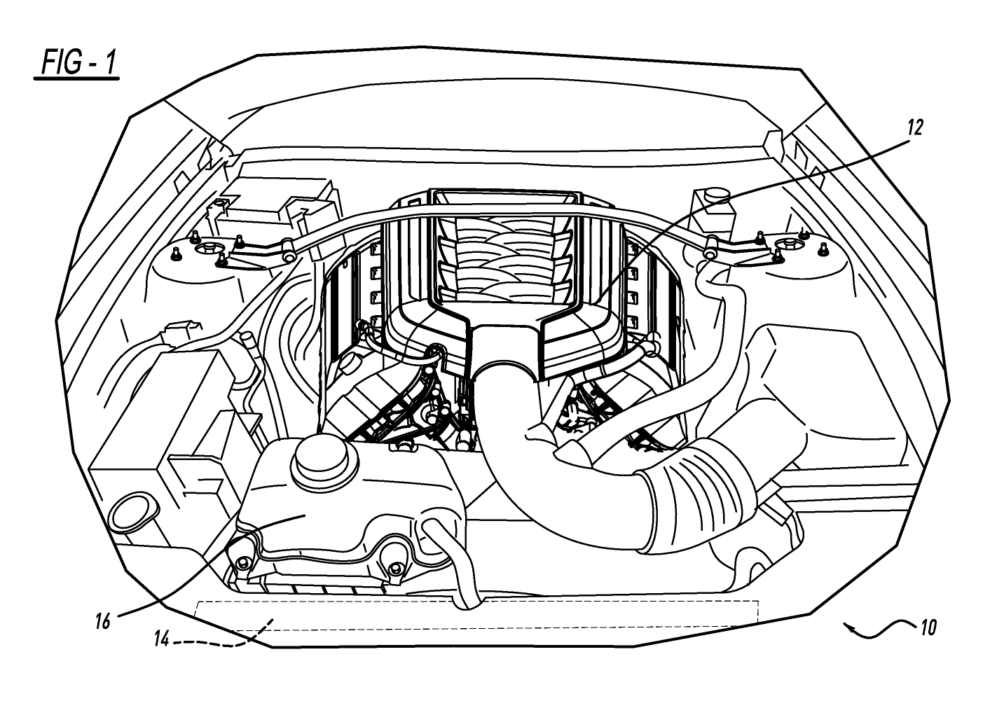

Referring to FIG. 1, an environmental view of an engine compartment 10 is illustrated. Within the engine compartment 10 are located an engine 12, a radiator 14 illustrated in broken lines, and a coolant reservoir 16 according to the disclosed inventive concept. The number, placement and shapes of the components within the engine compartment 10 may be varied from those illustrated in FIG. 1 without deviating from the scope of the disclosed inventive concept.

The position of the coolant reservoir 16 illustrated in FIG. 1 is the position the coolant reservoir 16 would have under normal operating circumstances. As illustrated, the coolant reservoir 16 is within the Pedestrian Protection Zone. In an impact event, the coolant reservoir 16 would be pushed downward and out of the Pedestrian Protection Zone, thereby reducing injury to a pedestrian.

Movement of the coolant reservoir from its normal position illustrated in FIG. 1 to a position out of the Pedestrian Protection Zone in an impact event is made possible by flexible or movable arm arrangements. The various embodiments of these arrangements are illustrated in FIGS. 1 through 15.

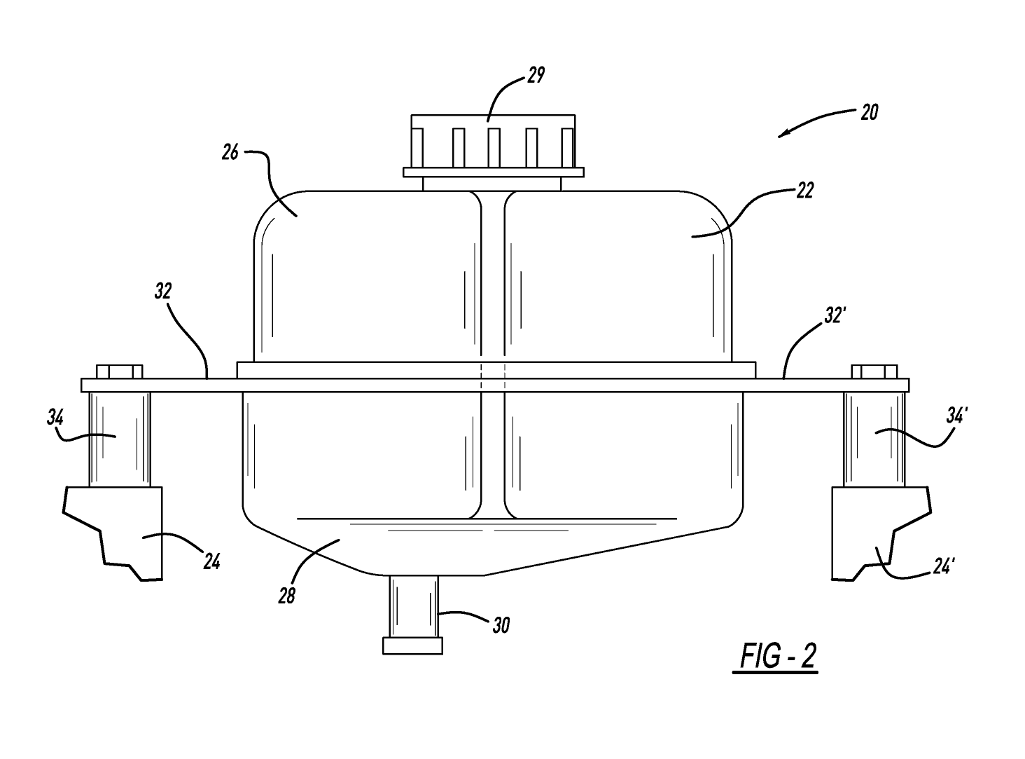

Referring to FIG. 2, a side view of an isolated coolant reservoir assembly according to an embodiment of the disclosed inventive concept is illustrated generally as 20. The isolated coolant reservoir assembly 20 includes an isolated coolant reservoir 22 shown in relation to fixed vehicle body support structures 24 and 24′. The isolated coolant reservoir 22 includes an upper portion 26 and a lower portion 28 attached to the upper portion 26. A reservoir fill inlet 29 is formed as part of the upper portion 26 while a fluid drain 30 is formed as part of the lower portion 28.

A pair of integrally molded arms 32 and 32′ extend from the sides of the isolated coolant reservoir 22. The arms 32 and 32′ are illustrated as being formed as part of the lower portion 28 but may alternatively be part of the upper portion 26 or part of both the upper portion 26 and the lower portion 28.

To provide isolation, a pair of compressible and resilient elastomeric isolators 34 and 34′ is provided for attachment of the isolated coolant reservoir 22 to the fixed vehicle body support structures 24 and 24′. Particularly, an elastomeric isolator 34 is positioned between the integrally molded arm 32 and the fixed vehicle body support structure 24 and an elastomeric isolator 34′ is positioned between the integrally molded arm 32′ and the fixed vehicle body support structure 24.

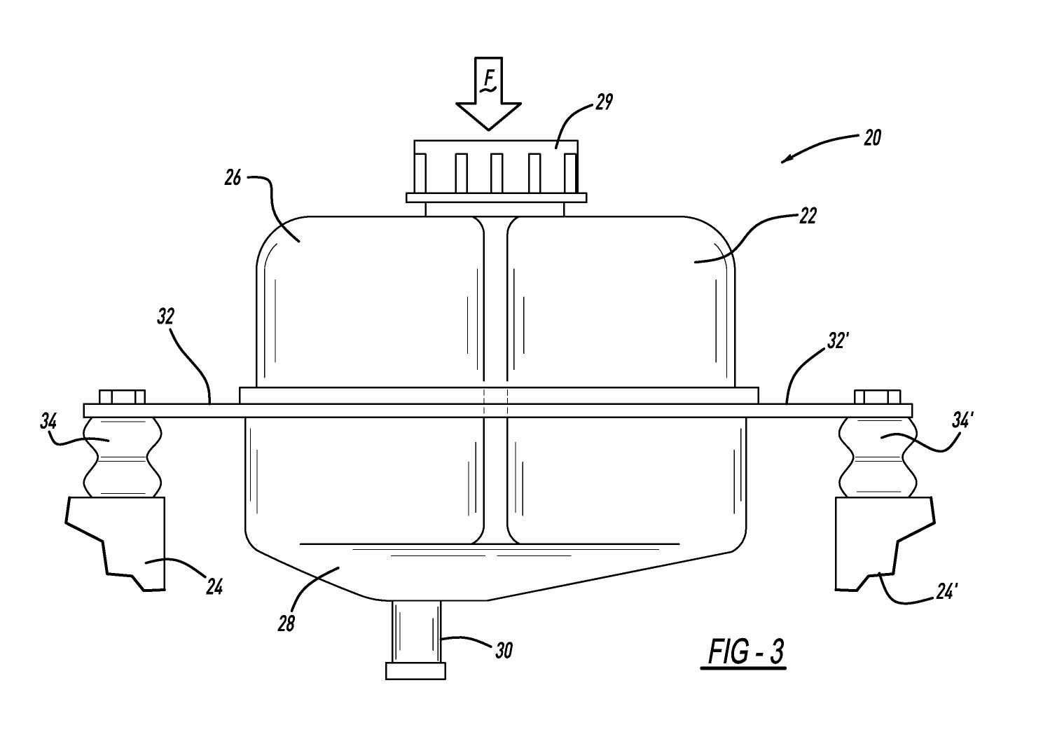

The isolated coolant reservoir assembly 20 is shown in FIG. 2 in its operational, pre-impact event position within the Pedestrian Protection Zone. In an impact event, the isolated coolant reservoir 22 is moved to a position out of the Pedestrian Protection Zone as illustrated in FIG. 3 by Force F. As illustrated in that figure, the elastomeric isolators 34 and 34′ are shown in their compressed conditions allowing the isolated coolant reservoir 22 to be moved into the Pedestrian Protection Zone and out of the way of the pedestrian.

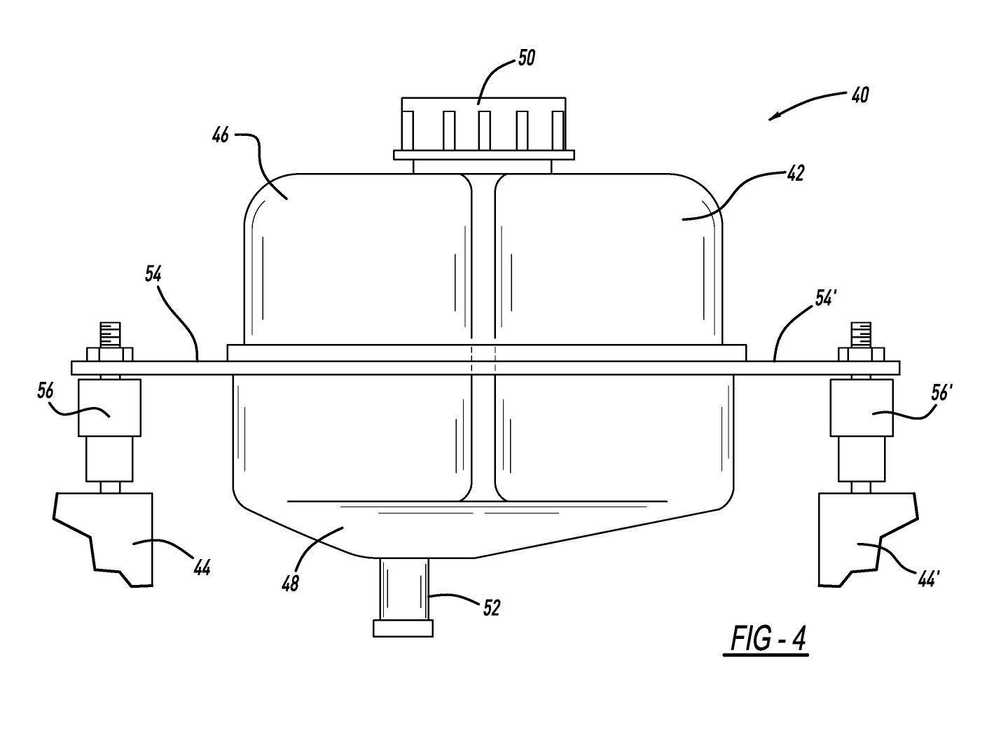

Referring to FIG. 4, a side view of an isolated coolant reservoir assembly according to another embodiment of the disclosed inventive concept is illustrated generally as 40. The isolated coolant reservoir assembly 40 includes an isolated coolant reservoir 42 shown in relation to fixed vehicle body support structures 44 and 44′. The isolated coolant reservoir 42 includes an upper portion 46 and a lower portion 48 attached to the upper portion 46. A reservoir fill inlet 50 is formed as part of the upper portion 46 while a fluid drain 52 is formed as part of the lower portion 48.

A pair of integrally molded arms 54 and 54′ extend from the sides of the isolated coolant reservoir 42. The arms 54 and 54′ are illustrated as being formed as part of the lower portion 48 but may alternatively be part of the upper portion 46 or part of both the upper portion 46 and the lower portion 48.

To provide isolation, a pair of compressible dampers 56 and 56′ is provided for attachment of the isolated coolant reservoir 42 to the fixed vehicle body support structures 44 and 44′. The dampers 56 and 56′ may be liquid filled (such as an oil) or gas filled. A damper 56 is provided between the integrally molded arm 54 and the fixed body support structure 44 while a damper 56′ is provided between the integrally molded arm 54′ and the fixed body support structure 44′.

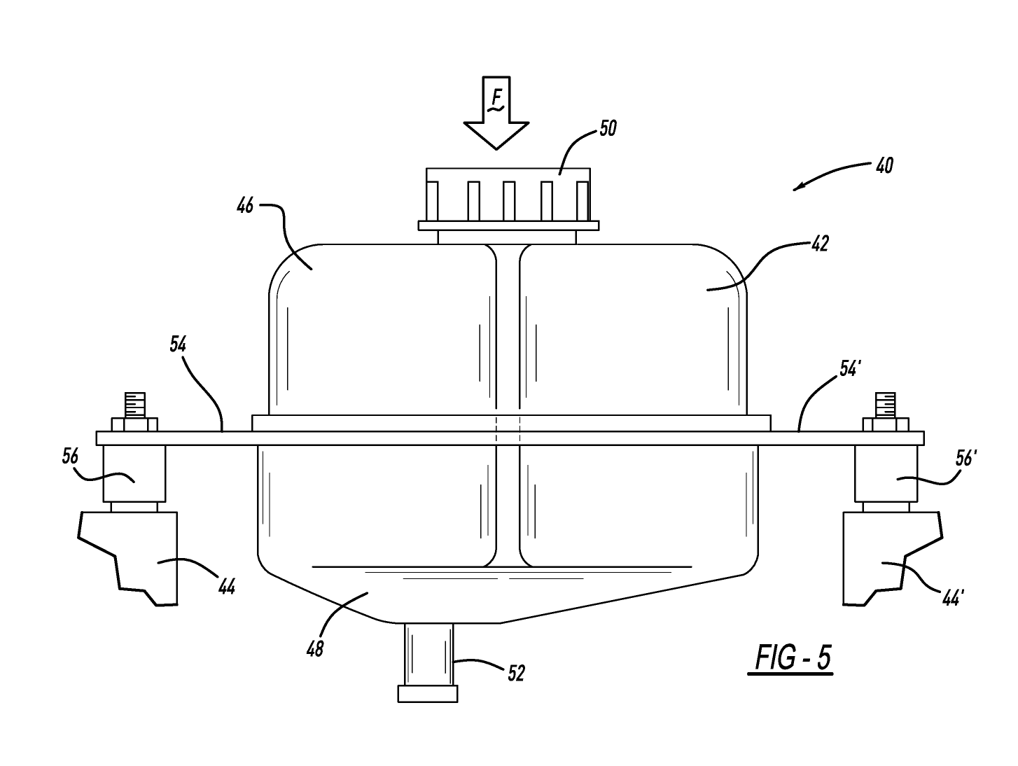

The isolated coolant reservoir assembly 40 is shown in FIG. 4 in its operational, pre-impact event position within the Pedestrian Protection Zone. In an impact event, the isolated coolant reservoir 42 is moved to a position out of the Pedestrian Protection Zone as illustrated in FIG. 5 by Force F. As illustrated in that figure, the compressible dampers 56 and 56′ are shown in their compressed conditions allowing the isolated coolant reservoir 42 to be moved into the Pedestrian Protection Zone and out of the way of the pedestrian.

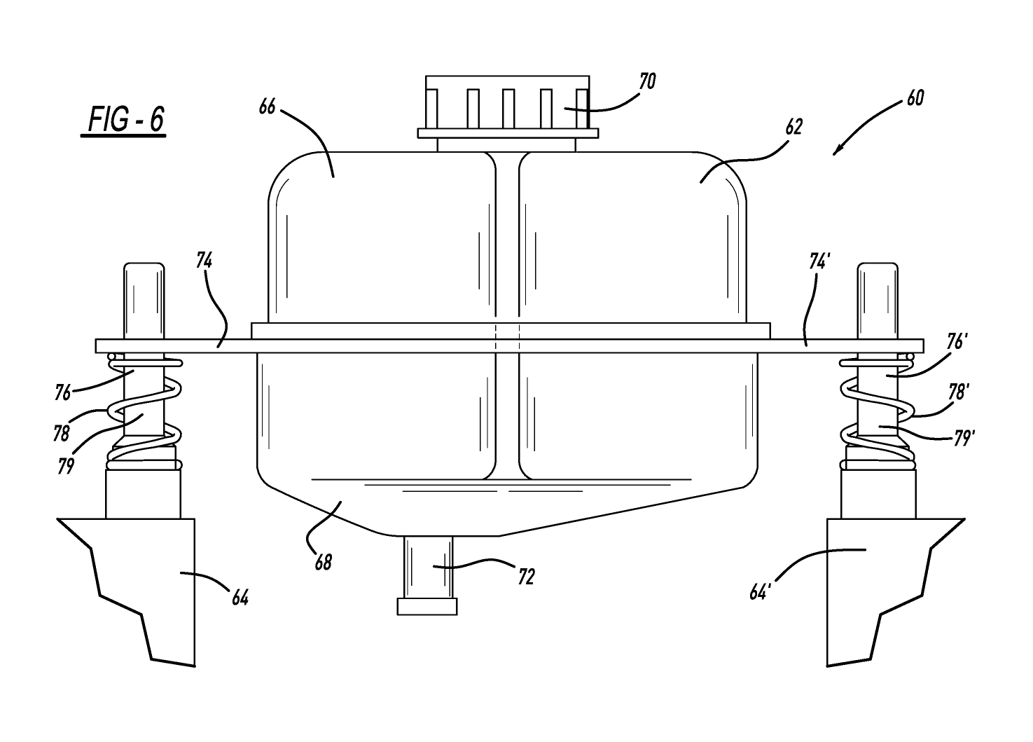

Referring to FIG. 6, a side view of an isolated coolant reservoir assembly according to still another embodiment of the disclosed inventive concept is illustrated generally as 60. The isolated coolant reservoir assembly 60 includes an isolated coolant reservoir 62 shown in relation to fixed vehicle body support structures 64 and 64′. The isolated coolant reservoir 62 includes an upper portion 66 and a lower portion 68 attached to the upper portion 66. A reservoir fill inlet 70 is formed as part of the upper portion 66 while a fluid drain 72 is formed as part of the lower portion 68.

A pair of integrally molded arms 74 and 74′ extend from the sides of the isolated coolant reservoir 62. The arms 74 and 74′ are illustrated as being formed as part of the lower portion 68 but may alternatively be part of the upper portion 66 or part of both the upper portion 66 and the lower portion 68.

To provide isolation, a pair of spring assemblies 76 and 76′ is provided for attachment of the isolated coolant reservoir 62 to the fixed vehicle body support structures 64 and 64′. The spring assembly 76 is fitted between the integrally molded arm 74 and the body support structure 64. The spring assembly 76 includes a spring 78 fitted around a spring guide 79. The spring assembly 76′ is fitted between the integrally molded arm 74′ and the body support structure 64′. The spring assembly 76′ includes a spring 78′ fitted around a spring guide 79′.

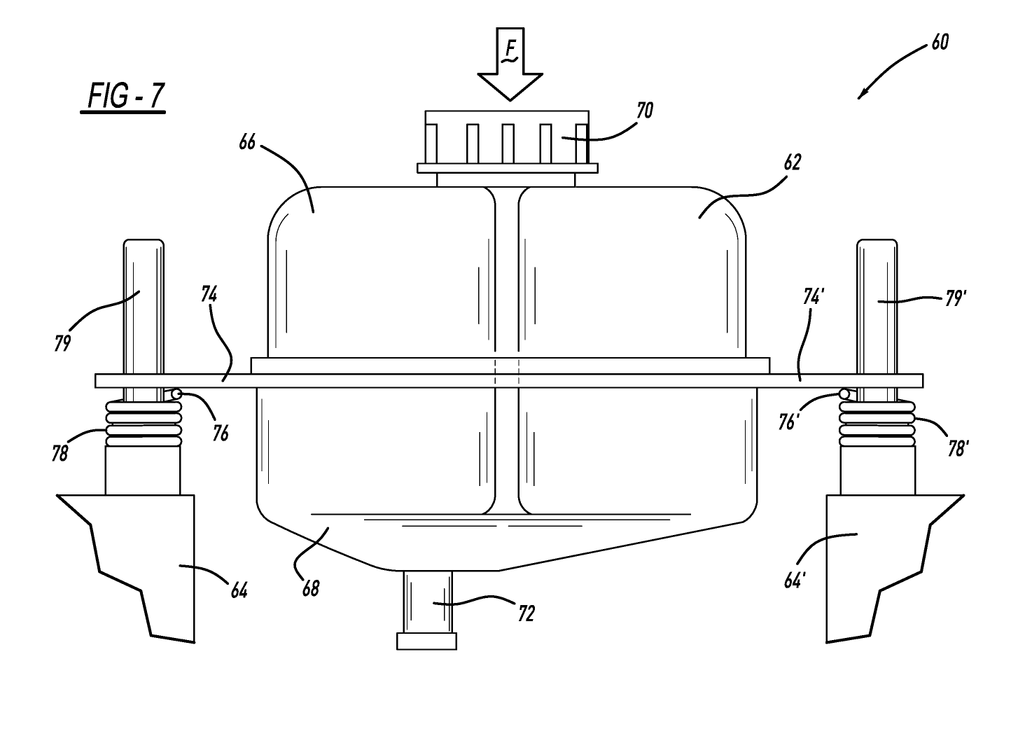

The isolated coolant reservoir assembly 60 is shown in FIG. 6 in its operational, pre-impact event position within the Pedestrian Protection Zone. In an impact event, the isolated coolant reservoir 62 is moved to a position out of the Pedestrian Protection Zone as illustrated in FIG. 7 by Force F. As illustrated in that figure, the spring assemblies 76 and 76′ are shown in their compressed conditions allowing the isolated coolant reservoir 62 to be moved into the Pedestrian Protection Zone and out of the way of the pedestrian.

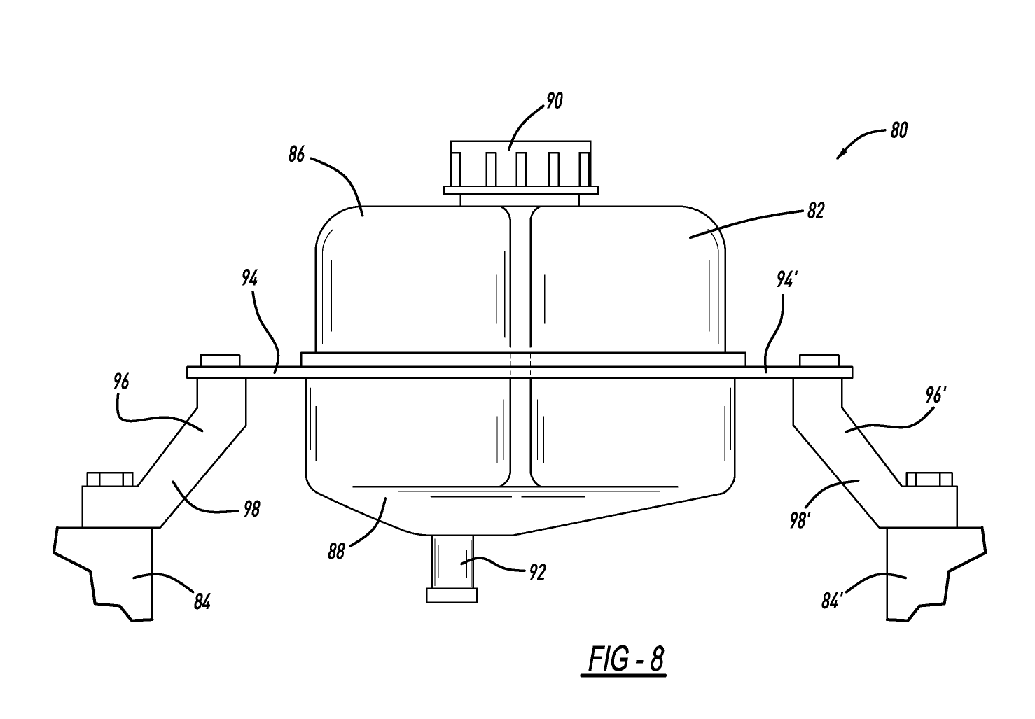

Referring to FIG. 8, a side view of an isolated coolant reservoir assembly according to still another embodiment of the disclosed inventive concept is illustrated generally as 80. The isolated coolant reservoir assembly 80 includes an isolated coolant reservoir 82 shown in relation to fixed vehicle body support structures 84 and 84′. The isolated coolant reservoir 82 includes an upper portion 86 and a lower portion 88 attached to the upper portion 86. A reservoir fill inlet 90 is formed as part of the upper portion 86 while a fluid drain 92 is formed as part of the lower portion 88.

A pair of integrally molded arms 94 and 94′ extend from the sides of the isolated coolant reservoir 82. The arms 94 and 94′ are illustrated as being formed as part of the lower portion 88 but may alternatively be part of the upper portion 86 or part of both the upper portion 86 and the lower portion 88.

To provide isolation, a pair of elongated elastomeric isolators 96 and 96′ is provided for attachment of the isolated coolant reservoir 82 to the fixed vehicle body support structures 84 and 84′. The elongated elastomeric isolator 96 includes an angular arm segment 98. The elongated elastomeric isolator 96 is fitted between the integrally molded arm 94 and the body support structure 84. The elongated elastomeric isolator 96′ includes an angular arm segment 98′. The elongated elastomeric isolator 96′ is fitted between the integrally molded arm 94′ and the body support structure 84′.

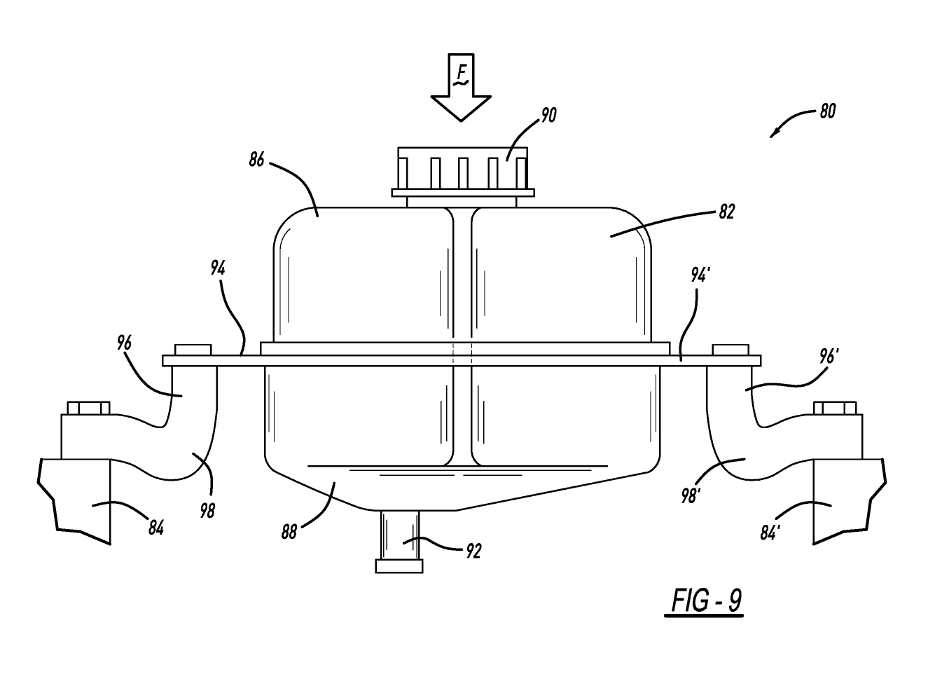

The isolated coolant reservoir assembly 80 is shown in FIG. 8 in its operational, pre-impact event position within the Pedestrian Protection Zone. In an impact event, the isolated coolant reservoir 82 is moved to a position out of the Pedestrian Protection Zone as illustrated in FIG. 9 by Force F. As illustrated in that figure, the pair of elongated elastomeric isolators 96 and 96′ are shown in their bent conditions in which the angular arm segments 98 and 98′ have been primarily flexed thereby allowing the isolated coolant reservoir 82 to be moved into the Pedestrian Protection Zone and out of the way of the pedestrian.

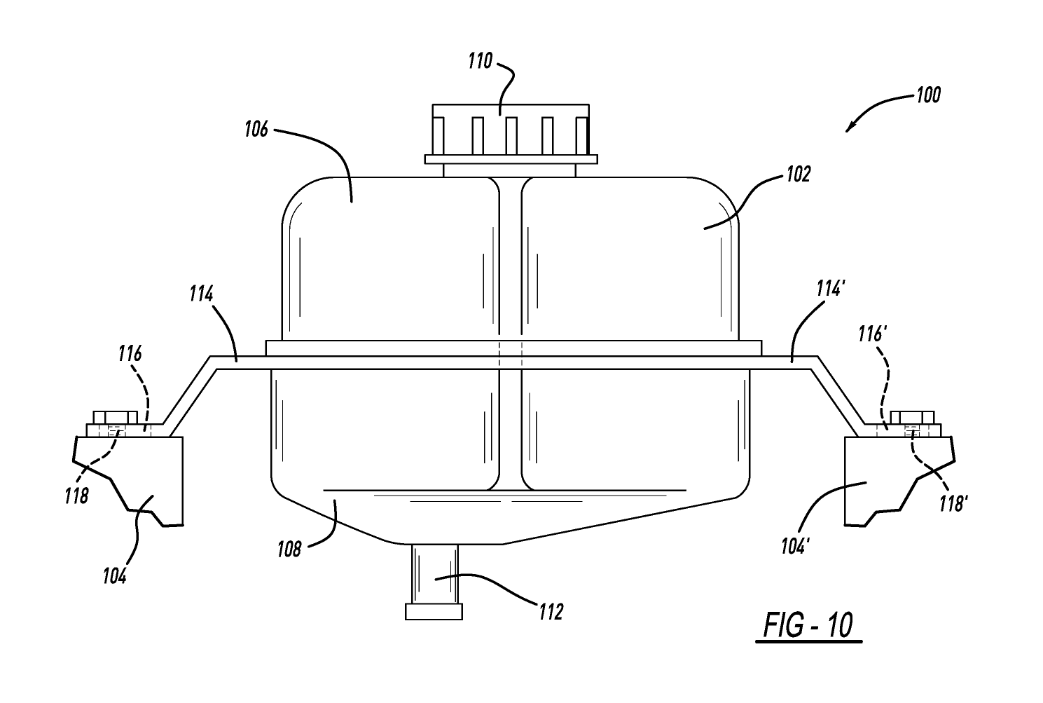

Referring to FIG. 10, a side view of an isolated coolant reservoir assembly according to a further embodiment of the disclosed inventive concept is illustrated generally as 100. The isolated coolant reservoir assembly 100 includes an isolated coolant reservoir 102 shown in relation to fixed vehicle body support structures 104 and 104′. The isolated coolant reservoir 102 includes an upper portion 106 and a lower portion 108 attached to the upper portion 106. A reservoir fill inlet 110 is formed as part of the upper portion 106 while a fluid drain 112 is formed as part of the lower portion 108.

A pair of integrally molded arm extensions 114 and 114′ extend from the sides of the isolated coolant reservoir 102. The arm extensions 114 and 114′ are illustrated as being formed as part of the lower portion 108 but may alternatively be part of the upper portion 106 or part of both the upper portion 106 and the lower portion 108.

The integrally molded arm extensions 114 and 114′ provide isolation of the reservoir 102 from the body support structures 104 and 104′. The distal end of the integrally molded arm extension 114 includes a slot 116 and the distal end of the integrally molded arm extension 114′ includes a slot 116′. A bolt having a shank 118 extends through the slot 116 and into the body support structure 104. A bolt having a shank 118′ extends through the slot 116′ and into the body support structure 104′. The integrally molded arm extension 114 includes a middle segment 119 and the integrally molded arm 114′ includes a middle segment 119′.

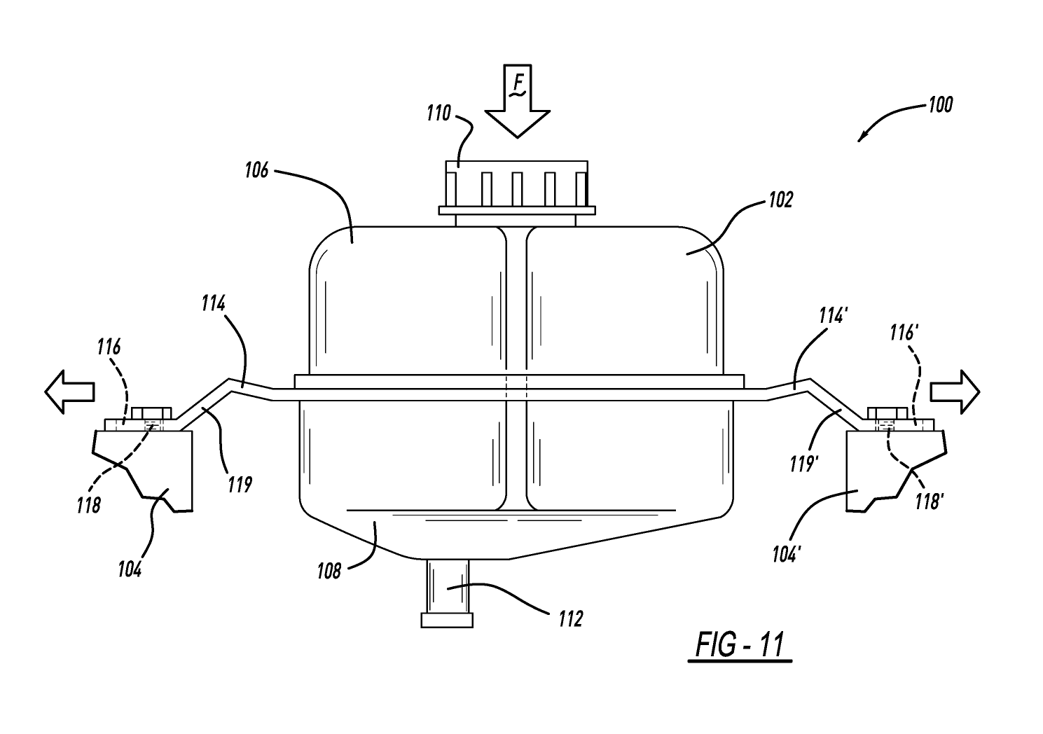

The isolated coolant reservoir assembly 100 is shown in FIG. 10 in its operational, pre-impact event position within the Pedestrian Protection Zone. In an impact event, the isolated coolant reservoir 102 is moved to a position out of the Pedestrian Protection Zone as illustrated in FIG. 11 by Force F. As illustrated in that figure, the pair of integrally molded arm extensions 114 and 114′ are shown in their flexed conditions in which the middle segments 119 and 119′ are slightly flattened with the distal ends of the arm extensions 114 and 114′ being moved such that the bolt shanks 118 and 118′ have contacted the inner walls of the slots 116 and 116′ respectively. In this position, the isolated coolant reservoir 102 is moved into the Pedestrian Protection Zone and out of the way of the pedestrian.

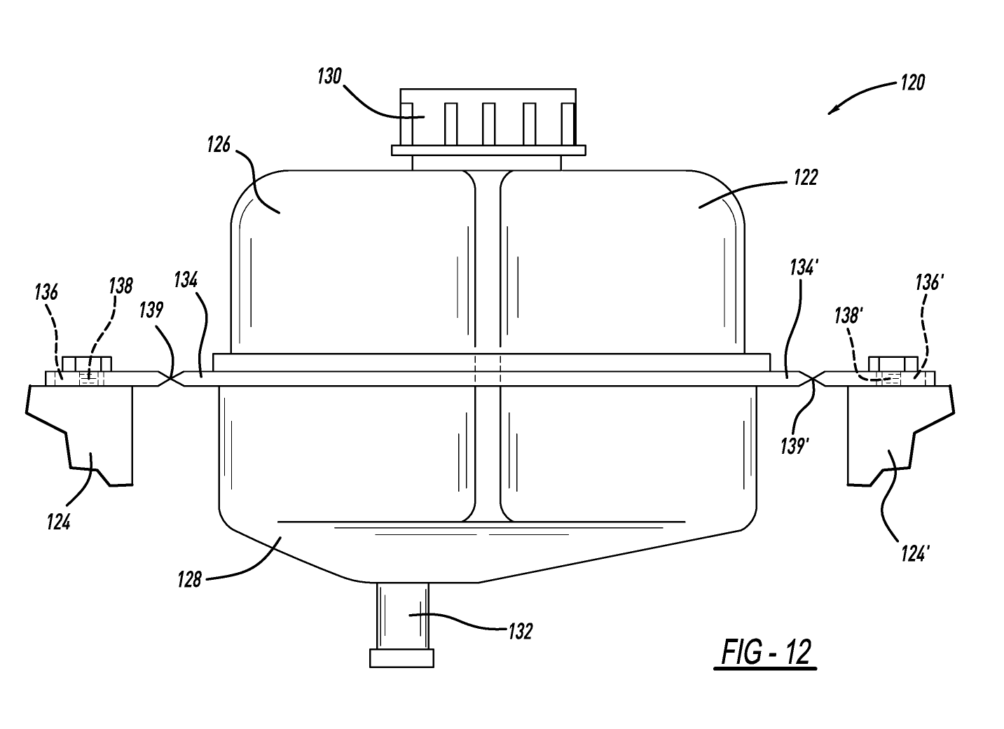

Referring to FIG. 12, a side view of an isolated coolant reservoir assembly according to a further embodiment of the disclosed inventive concept is illustrated generally as 120. The isolated coolant reservoir assembly 120 includes an isolated coolant reservoir 122 shown in relation to fixed vehicle body support structures 124 and 124′. The isolated coolant reservoir 122 includes an upper portion 126 and a lower portion 128 attached to the upper portion 126. A reservoir fill inlet 130 is formed as part of the upper portion 126 while a fluid drain 132 is formed as part of the lower portion 128.

A pair of integrally molded arm extensions 134 and 134′ extend from the sides of the isolated coolant reservoir 122. The arm extensions 134 and 134′ are illustrated as being formed as part of the lower portion 128 but may alternatively be part of the upper portion 136 or part of both the upper portion 136 and the lower portion 138.

The integrally molded arm extensions 134 and 134′ provide isolation of the reservoir 122 from the body support structures 124 and 124′. The distal end of the integrally molded arm extension 124 includes a slot 136 and the distal end of the integrally molded arm extension 124′ includes a slot 136′. A bolt having a shank 138 extends through the slot 136 and into the body support structure 124. A bolt having a shank 138′ extends through the slot 136′ and into the body support structure 124′. The integrally molded arm extension 134 includes a pinched point or living hinge 139 and the integrally molded arm 134′ includes a pinched point or living hinge 139′.

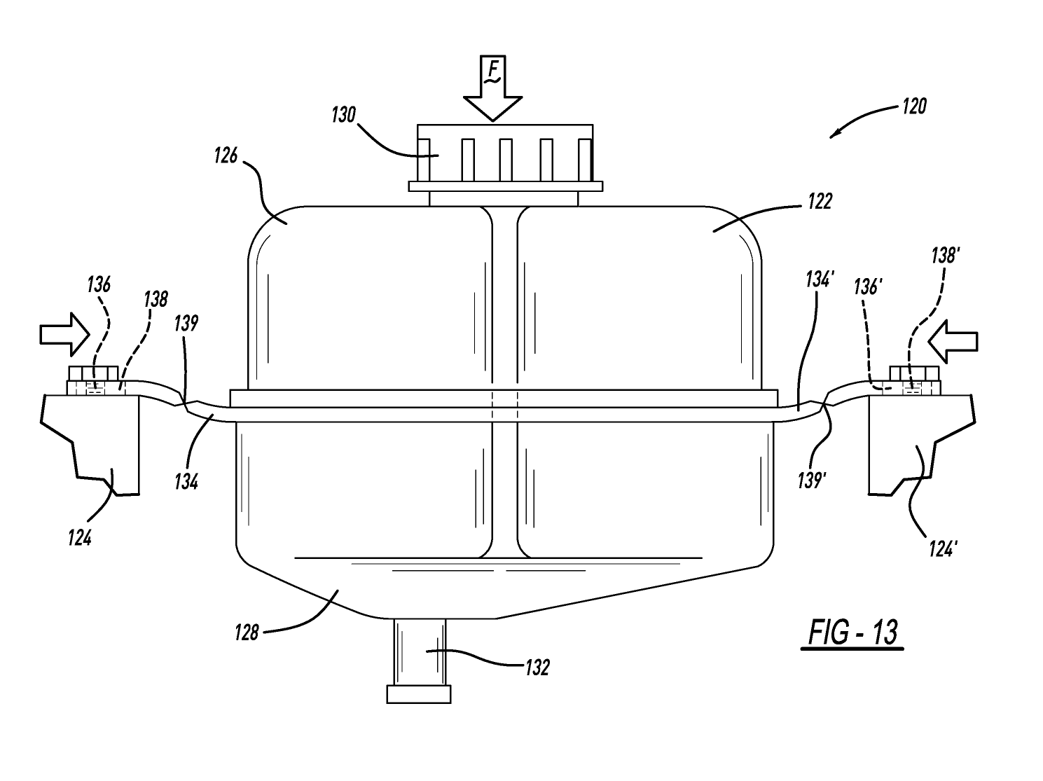

The isolated coolant reservoir assembly 120 is shown in FIG. 12 in its operational, pre-impact event position within the Pedestrian Protection Zone. In an impact event, the isolated coolant reservoir 122 is moved to a position out of the Pedestrian Protection Zone as illustrated in FIG. 13 by Force F. As illustrated in that figure, the pair of integrally molded arm extensions 134 and 134′ are shown in their flexed conditions in which the living hinges 139 and 139′ allow for twisting of the arm extensions 134 and 134′ with the distal ends of the arm extensions 134 and 13′ being moved such that the bolt shanks 138 and 138′ have contacted the inner walls of the slots 136 and 136′ respectively. In this position, the isolated coolant reservoir 122 is moved into the Pedestrian Protection Zone and out of the way of the pedestrian.

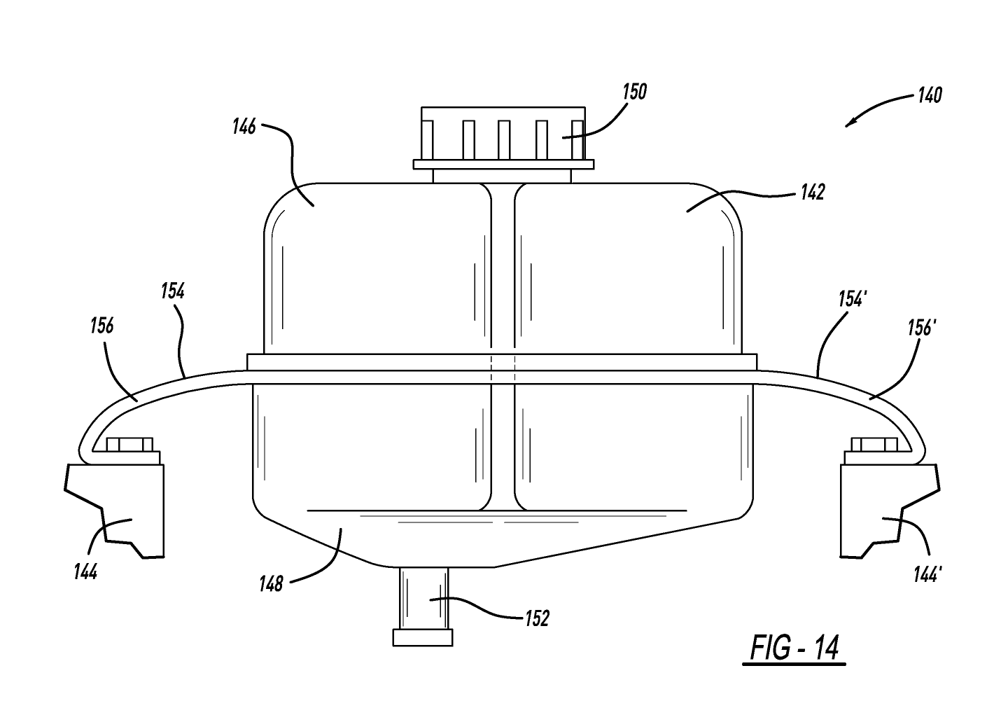

Referring to FIG. 14, a side view of an isolated coolant reservoir assembly according to still another embodiment of the disclosed inventive concept is illustrated generally as 140. The isolated coolant reservoir assembly 140 includes an isolated coolant reservoir 142 shown in relation to fixed vehicle body support structures 144 and 144′. The isolated coolant reservoir 142 includes an upper portion 146 and a lower portion 148 attached to the upper portion 146. A reservoir fill inlet 150 is formed as part of the upper portion 146 while a fluid drain 152 is formed as part of the lower portion 148.

A pair of integrally molded arm extensions 154 and 154′ extend from the sides of the isolated coolant reservoir 142. The arm extensions 154 and 154′ are illustrated as being formed as part of the lower portion 148 but may alternatively be part of the upper portion 146 or part of both the upper portion 146 and the lower portion 148.

The integrally molded arm extensions 154 and 154′ provide isolation of the reservoir 142 from the body support structures 144 and 144′. The arm extension 154 includes a flexible arcuate segment 156 and the arm extension 154′ includes a flexible arcuate segment 156′.

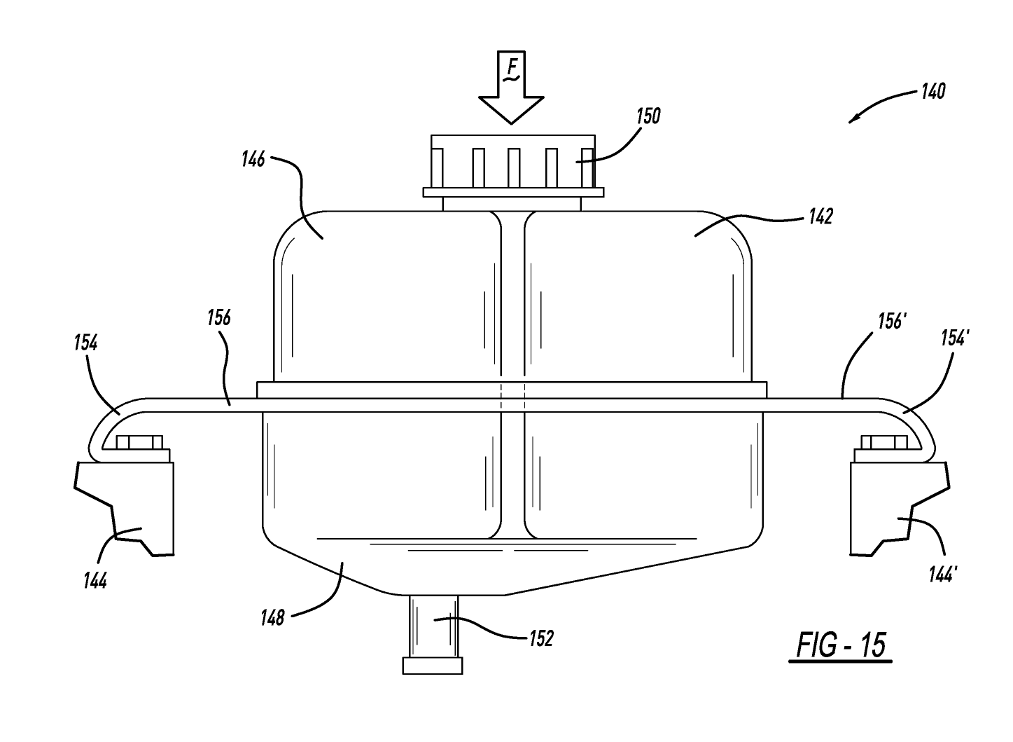

The isolated coolant reservoir assembly 140 is shown in FIG. 14 in its operational, pre-impact event position within the Pedestrian Protection Zone. In an impact event, the isolated coolant reservoir 142 is moved to a position out of the Pedestrian Protection Zone as illustrated in FIG. 15 by Force F. As illustrated in that figure, the pair of integrally molded arm extensions 154 and 154′ are shown in their flexed conditions in which the flexible arcuate segments 156 and 156′ are slightly flattened. In this position, the isolated coolant reservoir 142 is moved into the Pedestrian Protection Zone and out of the way of the pedestrian.

Thus, the disclosed invention as set forth above overcomes the challenges faced by known engine cover assemblies by increasing ease of assembly and ease of use. However, one skilled in the art will readily recognize from such discussion, and from the accompanying drawings and claims that various changes, modifications and variations can be made therein without departing from the true spirit and fair scope of the invention as defined by the following claims.

1. A vehicle cooling system comprising:
a body structure;
a radiator attached to said structure;
a reservoir fluidly attached to said radiator, said reservoir having a first side with a first integrally molded arm and a second side with a second integrally molded arm; and
a first isolator between said first arm and said structure and a second isolator between said second arm and said structure, said isolators being reversible from operational positions to impact-responsive positions.

2. The vehicle cooling system of claim 1, wherein said isolators are formed as separate components and are attached to said arms and to said structure.

3. The vehicle cooling system of claim 2, wherein each of said isolators is composed of an elastomer.

4. The vehicle cooling system of claim 3, wherein said reservoir has a long axis and said elastomeric isolator has a long axis, said long axis of said isolator being positioned generally perpendicular relative to said long axis of said reservoir.

5. The vehicle cooling system of claim 3, wherein said reservoir has a long axis and said elastomeric isolator has a long axis, said long axis of said isolator being positioned generally at an angle relative to said long axis of said reservoir.

6. The vehicle cooling system of claim 2, wherein each of said isolators is a two-piece damper filled with a fluid.

7. The vehicle cooling system of claim 2, wherein each of said isolators comprises a central elongated shaft and a spring coaxially positioned around said shaft.

8. The vehicle cooling system of claim 1, wherein said isolators are elongated arm extensions formed integral with said arms.

9. The vehicle cooling system of claim 8 wherein each of said elongated arm extension has a distal end, said distal end having an elongated slot therein, said system further including fasteners, one of said fasteners extending through said slot and into said structure for attachment thereto.

10. The vehicle cooling system of claim 9, wherein said elongated arm extension has a shape, said shape being flat.

11. The vehicle cooling system of claim 9, wherein said elongated arm extension has a shape, said shape being arcuate.

12. The vehicle cooling system of claim 9, wherein said elongated arm extension includes a living hinge.

13. An isolated fluid reservoir for use in a vehicle having a body structure, the reservoir comprising:
an upper portion;
a lower portion connected to said upper portion;
a first arm integrally formed with one of said portions;
a second arm integrally molded with one of said portions; and
isolators flexibly connecting said arms to the body structure, whereby said isolators allow the reservoir to be displaced between a passenger impact zone and an out-of-zone position.

14. The isolated fluid reservoir of claim 13, wherein said isolators are formed as separate components and are attached to said arms and to the structure.

15. The isolated fluid reservoir of claim 14, wherein each of said isolators is composed of an elastomer.

16. The isolated fluid reservoir of claim 13, wherein each of said isolators is a two-piece damper filled with a fluid.

17. The isolated fluid reservoir of claim 13, wherein said isolators are elongated arm extensions formed integral with said arms.

18. The isolated fluid reservoir of claim 17 wherein each of said elongated arm extension has a distal end, said distal end having an elongated slot therein, said system further including fasteners, one of said fasteners extending through said slot and into said structure for attachment thereto.

19. The vehicle cooling system of claim 9, wherein said elongated arm extension has a shape, said shape being selected from the group consisting of flat, arcuate and pinched.

20. An isolated fluid reservoir for use in a vehicle having a body structure, the reservoir comprising:
an upper portion;
a lower portion connected to said upper portion;
a first arm integrally formed with one of said portions;
a second arm integrally molded with one of said portions; and
isolators flexibly connecting said arms to the body structure, said isolators being selected from the group consisting of separate components attaching said arms to the structure and elongated arm extensions formed integral with said arms, whereby said isolators allow the reservoir to be displaced between a passenger impact zone and an out-of-zone position.

21. The isolated fluid reservoir of claim 20, wherein each of said isolators is a two-piece damper filled with a fluid.

22. The isolated fluid reservoir of claim 20, wherein said upper portion includes a reservoir fill inlet.

23. The isolated fluid reservoir of claim 20, wherein said lower portion includes a fluid drain.

24. The isolated fluid reservoir of claim 13, wherein said upper portion includes a reservoir fill inlet.

25. The isolated fluid reservoir of claim 13, wherein said lower portion includes a fluid drain.
